(19) United States
(12) Patent Application Publication
(10) Pub. No.: US 2005/0278742 A1
(43) Pub. Date: Dec. 15, 2005

(54) Method and apparatus for the display of a viewing events list

(75) Inventor: Anton Komar, Toronto (CA)

Correspondence Address: VEDDER PRICE KAUFMAN & KAMMHOLZ, 222 N. LASALLE STREET, CHICAGO, IL, 60601, US

(73) Assignee: ATI Technologies, Inc., Markham (CA)

(21) Appl. No.: 10/864,019

(22) Filed: Jun. 9, 2004

(51) Int. Cl. H04N 5/445; G06F 3/00; G06F 13/00

(52) U.S. Cl. 725/46; 725/45

(57) ABSTRACT

A method and apparatus for the display of a viewing events list, wherein a viewing events list includes receiving a plurality of viewing event indicators, wherein each of the plurality of viewing event indicators is associated with event information. The viewing event indicators includes some form of indication of a corresponding underlying viewing event. The method and apparatus further includes prioritizing the viewing event indicators based on the viewing event information and at least one priority rule. The method and apparatus further includes generating the viewing events list including a priority-based listing of the viewing event indicators. Through the association of the priority rules and the corresponding available viewing event indicators, a structured list is provided prioritizing viewing events to assist in a viewer selecting what to watch based on define preferences and priority rules.

### FIELD OF THE INVENTION

The present invention relates generally to electronic program guides and more specifically to the filtering and display of electronic program guide information.

### BACKGROUND OF THE INVENTION

Existing television viewing systems typically include a grid based electronic programming guide. A typical television broadcast includes data representing three individual data fields. The first data field is a channel lineup which defines all of the specific channels available for viewing. The second data is a show lineup which includes all of the data relating to the individual shows being displayed. The third data field is a schedule which coordinates when a particular viewing event from the show lineup is available for viewing.

In a typical electronic programming guide display system, the show lineup data represents the available viewing events, for example the specific televisions broadcast show or episode, such as an episode of the sitcom Friends or a recurring show such as the 6 O'clock Evening News. Each of the viewing events may be identified by a representative multi-digit number. Further associated with the number are index coordinates associated with a particular viewing grid. A processing device, such as a television set top box, when enabled by an end user creates a rectangular grid including time along the X axis and viewing channels along the Y axis. Based on the particular grid, the show lineup is then utilized to populate the grid by placing particular viewing events at the coordinated location within the grid. For example, for an evening news program starting on Channel 2 at 6:00, the X axis of the grid, time, for the 6:00 interval and Channel 2 on the Y axis interval would provide the coordinates for the insertion of the viewing event within the grid. Therefore, when a viewer enables the electronic program guide, the grid display of viewing information is generated, showing, among other viewing events, the evening news program available on Channel 2 at 6:00.

Further advances with electronic program guides allow for further information to be provided within the show lineup data fields. For example, a viewing event is typically labeled with a common name such that a viewer may actively recognize the name of the viewing event, for example, an episode of Friends. Further included may be information describing the plot of the episode, actor information, season and/or episode information, if the show is a new episode or a rerun, or any other information relating to providing the user with programming guide information.

Currently, more and more channels are becoming available for a viewing. Therefore, more and more options are becoming available for viewing content. Furthermore, with the advent of personal video recording devices (PVRs), users have also added large amounts of recorded viewing information. Therefore, modern television viewing systems provide a veritable information overload with regards to viewable content. The information overload can be further propagated due to PVR systems recording content based on user-preferences without the users express permission or knowledge. Based on the information overload, modern systems allow users to easily overlook viewing events. This may be especially true for seasonal content broadcast only once per year, for example, a particular sporting event.

Current programming guide information systems also allow for a user to search through available content. Searching features may be cumbersome based on ambiguities with regards to defined search characteristics. For example, different broadcasters may provide different descriptions of similar events, such as a world sports station describing a soccer event as football and a U.S. broadcast station also using the term football, but not directly referring to the sport of soccer.

The current program guide information will also allow a user to set specific channel favorites. Using an on-screen interactive menu, the user may select favorite channels, such that when the grid based display is generated, only the favorite channels are displayed on the Y axis and the corresponding program events are displayed in populating the grid relative to the time X axis.

Therefore, there exists a need for an approach to the processing of program guide information and the subsequent display of the program information such that a user may quickly and automatically obtain pertinent viewing information.

### BRIEF DESCRIPTION OF THE DRAWINGS

FIG. 1 illustrates a schematic block diagram of an apparatus for the display of a viewing events list in accordance with one embodiment of the present invention;

FIG. 2 illustrates a flowchart of a method for the display of a viewing events list in accordance with one embodiment of the present invention;

FIG. 3 illustrates a graphical representation of a viewing events list in accordance with one embodiment of the present invention;

FIG. 4 illustrates a schematic block diagram of databases providing viewing event information in accordance with one embodiment of the present invention;

FIG. 5 illustrates a schematic block diagram of a portion of a priority rule calculation element of one embodiment of the present invention;

FIG. 6 illustrates a graphical representation of a point-based counter for formulating priority rules in accordance with one embodiment of the present invention; and

FIG. 7 illustrates another method for the display of a viewing events list in accordance with another embodiment of the present invention.

### DETAILED DESCRIPTION OF A PREFERRED EMBODIMENT

Briefly, the present invention includes a method and apparatus for the display of a viewing events list, wherein a viewing events list includes a structured display, such as a table, of program events available for viewing. The method and apparatus includes receiving a plurality of viewing event indicators, wherein each of the plurality of viewing event indicators is associated with event information. The viewing event indicators includes some form of indication of a corresponding underlying viewing event. For example, if a viewing event is a particular episode of a sitcom, the viewing event indicator may be the title of the show.

The method and apparatus further includes prioritizing the viewing event indicators based on the viewing event information and at least one priority rule. A priority rule may include any parameter defining a preference for a particular viewing event. For example, a priority rule may be a rule indicating that a viewer prefers viewing sporting events but further prefers sporting events when broadcast on a local station, thereby placing a priority on sporting events including local teams.

The method and apparatus further includes generating the viewing events list including a priority-based listing of the viewing event indicators. Through the association of the priority rules and the corresponding available viewing event indicators, a structured list is provided ranging from a high priority, indicating a higher probability that a user is likely to watch or want to watch a particular viewing event, to a low priority wherein a user is typically not going to view the event but may prefer having the ability to at least know the event is available for viewing. Thereupon, the viewing events list is capable of being provided to a display device, such as a television monitor, and being displayed thereon. As such, the present invention allows for improved channel-based viewing events listing based on prioritizing available viewing events in view of priority rules determined by either a user's preference or preset criteria.

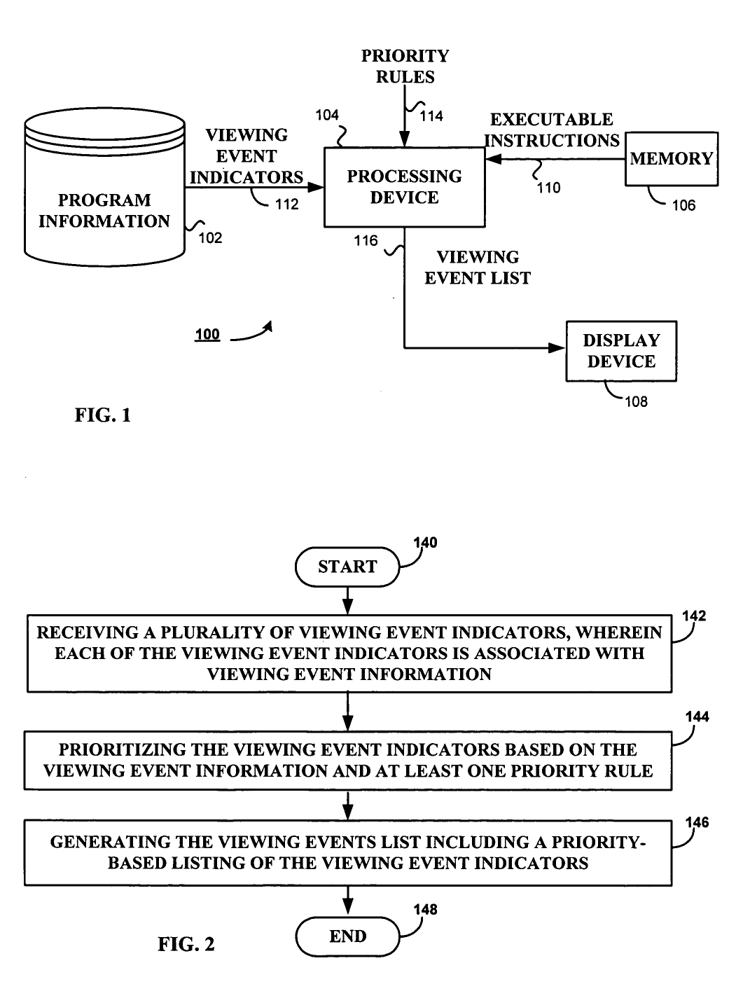

More specifically, FIG. 1 illustrates an apparatus 100 for the generation and display of a viewing events list. The apparatus 100 includes a program information database 102, the processing device 104, a memory 106 and a display device 108. The processing device 104 is operably coupled to the memory 106, wherein the memory 106 stores executable instructions 110 therein.

The processing device 104 is operative to perform operations in response to the executable instructions 110. The processing device 104 may be implemented in hardware, software or any other suitable implementation recognized by one having ordinary skill in the art. The processing device 104 may be any suitable processor including, but not limited to, a single processor, a plurality of processors, a DSP, a microprocessor, ASIC, state machine or any other implementation capable of processing and executing software or discrete logic or any suitable combination of hardware, software and/or firmware. The term processor should not be construed to refer exclusively to hardware capable of executing software, and may implicitly include DSP hardware, ROM for storing software, RAM and any other volatile or non-volatile storage medium. Moreover, the database of program information 102 and the memory 106 may be, but not limited to, a single memory, plurality of memory locations, shared memory, CD, DVD, ROM, RAM, EEPROM, optical storage, microcode, or any other non-volatile storage medium capable of storing digital data.

The processing device 104 is operative to receive viewing event indicators 112 from the program information database 102. The program information database 102 may be populated from any suitable source, such as described below with regards to FIG. 4. The processing device 104 is further operative to receive one or more priority rules 114. The priority rules 114 may be received from any suitable location, such as a storage location, user input, a table of priority rules as described below with respect to FIG. 5 or any other suitable location recognized by one having ordinary skill in the art.

The processing device 104 prioritizes the viewing event indicators 112 using the priority rule 114 to determine a viewing events list 114 that includes the priority-based listing of the viewing event indicators. In one embodiment of the present invention, the viewing events list 116 is generated by the processing device 104 based on a direct correlation of information included within the viewing event indicators 112 relative to the priority rules 114. For example, a priority rule 114 may include an indication of a user's preference for a particular genre and a particular broadcast station. Therefore, by cross referencing the viewing event indicators 112 with the priority rule 114, the viewing event indicators including viewing event title, viewing event information and viewing event broadcast channel information corresponding to the priority rules 114 will be granted a higher priority.

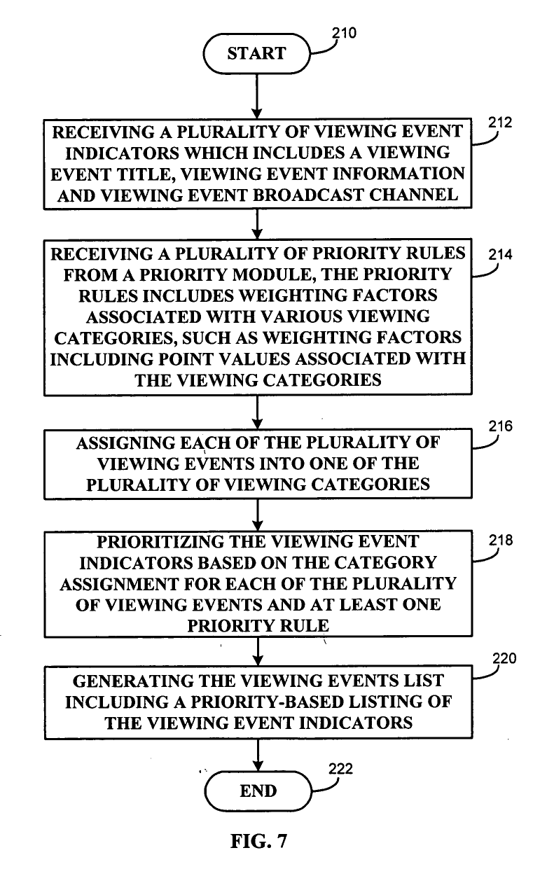

The priority rules 114 provide for a complete integration of all available reference elements, such as broadcast channel, title, event information, genre type or any other suitable information for creating the priority-based listing of viewing events within the viewing events list 116. As described below with regard to FIG. 6 and in one embodiment a point system may be used based on the active monitoring of viewing events selected by an end user. As noted above, in another embodiment priority rules 114 may be determined based on user activity or other inherent features such as tracking user selections or user-based requests for recording devices in a personal video recorder environment. In another embodiment, an interactive questionnaire or other user input solicitation vehicle may be utilized to acquire user-entered preferences.

In one embodiment of the present invention, the processing device 104 thereupon provides the viewing events list 116 to the display device 108. In response to a user indication, the display device 108 may then graphically display corresponding prioritized list of viewing events 116 having the highest priority events listed first and descending in priority to the bottom. The apparatus 100 may receive a user input request for an on-screen program guide and generate the viewing events list for display thereon. In one embodiment, the present invention may further include filtering the viewing events based on common viewing events occurring simultaneously on multiple channels, such as disclosed in corresponding U.S. patent application Ser. No. ______, having a title “METHOD AND APPARATUS FOR AUTOMATED DISPLAY OF VIDEO PROGRAMMING GUIDE INFORMATION”, having common Assignee.

In further with respect to FIG. 1, FIG. 2 illustrates the steps of a method for the display of a viewing events list in accordance with one embodiment of the present invention. The method begins, step 140, by receiving a plurality of viewing event indicators, wherein each of the viewing event indicators is associated with viewing event information, step 142. As discussed above with respect to FIG. 1, the viewing event indicators 112 are received by the processing device 104. Step 144 is prioritizing the viewing event indicators based on the viewing event information and at least one priority rule. The priority rules 114 are received by the processing device 104 such that step 146 is generating the viewing events list including a priority-based listing of the viewing event indicators. Again with respect to FIG. 1, the viewing events list 116 is generated by the processing device 106 and provided to the display device 108. Therefore, in one embodiment of the present invention, the method is complete, step 148.

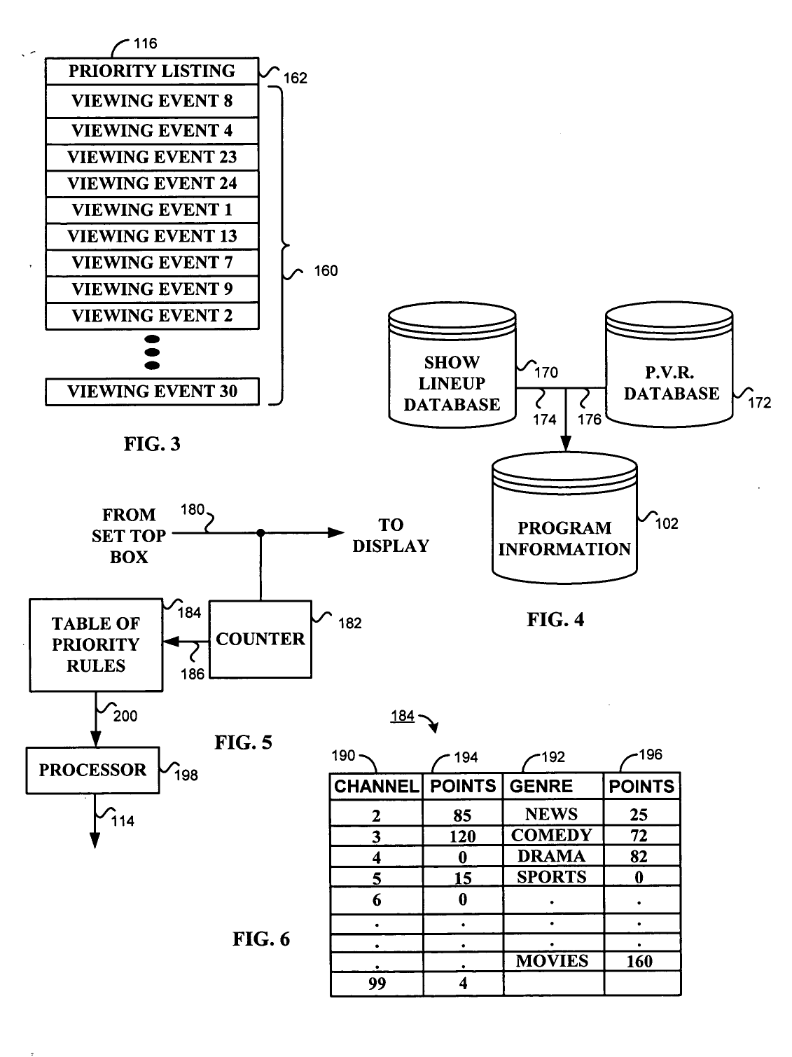

In one embodiment of the present invention, FIG. 3 illustrates a viewing events list 116 including a plurality of viewing event indicators 160 with a priority listing heading 162. The viewing event indicators are ordered in a priority-based ordering scheme with the highest priority viewing events, herein viewing event 8, listed first in a lowest priority event, viewing event 30, listed last. As noted above, the generic labeled viewing event indicators 160 represent corresponding user-based recognition, such as the title of a viewing event, for example an episode of the television show Friends. In the example of a sporting event, viewing event 8 may preferably read “U.S. Open Golf Championship,” or any other suitable listing such as the user is given a direct indication of the corresponding viewing event and has the option of availability for selecting and directing an underlying a television set top box or other tuning device for either actively changing to the viewing event, setting a reminder to view the event or setting a recorder device to record the underlying event indicated by the viewing event indicator 160.

As recognized by one having ordinary skill in the art, any suitable approach may be utilized to display the corresponding viewing events list 116 on the display device 108. In one exemplary embodiment, a display approach similar to the display approach utilized in corresponding U.S. patent application Ser. No. ______, having a title “METHOD AND APPARATUS FOR THE DISPLAY OF ELECTRONIC PROGRAM GUIDE INFORMATION”, having common Assignee may be used. Although, the present invention provides for the priority-based listing of viewing events in any suitable format. It should also be noted that the viewing events listed in the viewing events list 116 may not necessarily be timely based events and may also include recorded events associated with a personal video recorder (PVR) device, such as a digital recording device. It is within the present invention for the viewing events list 116 to include both active viewing events and previously recorded viewing events, such that a user may be provided with options of viewing high priority documents irrespective of the event presently airing being previously recorded.

FIG. 4 illustrates a schematic block diagram of one embodiment for populating the program information database 102. A show lineup database 170 and a PVR database 172 both are operative to store viewing event indicators therein. The show lineup database 170 may be populated in accordance with standard electronic program guide show lineup information within a standard television broadcast signal. The PVR database 172 may be populated based on a feedback of recorded events stored within an associated PVR device. Show lineup viewing event indicators 174 and PVR viewing event indicators 176 may thereupon be provided to the program information database 102 such that the program information database 102 may provide the viewing event indicators 112 to the processing device 104 as noted in FIG. 1. It should be noted that FIG. 4 is a representative illustration of one embodiment of the present invention and any suitable database structure may be utilized to populate the program information database 102.

FIG. 5 illustrates a graphical representation of one embodiment of an apparatus for determining priority rules. A display signal 180 provided from a set top box or any other suitable tuning device to a display device, such as the display 108 in FIG. 1, may be intercepted by a counter 182. The counter 182 tracks the viewing output to determine what a viewer is viewing. In one embodiment, the counter is coupled to a table of priority rules 184 such that the counter may provide an increment signal 186 to the table 184 to increment a point-based system for not only a corresponding channel selected in the display signal 180, but also the associated genre of the content being provided to the display. In one embodiment, preferential determinations may be made to set a minimum time interval prior to the counter 182 generating an increment signal 186 to the table 184. For example, if a user is surfing through different channels, it may not be efficient to generate increment signals 186 for every time a channel is changed. Therefore, a minimum time interval, such as two minutes may be set to indicate that a user is actively watching a particular viewing event and not just channel surfing. The counter 182 may further provide a set time interval for incrementing points in a table of priority rules 184.

FIG. 6 illustrates the graphical representation of a table of priority rules 184 having four exemplary columns, a channel category 190, a genre category 192, a points category 194 associated with the channel and a points category 196 associated with the genre 192.

Using an exemplary embodiment of a comedy event being broadcast on Channel 3 on the signal 180 to the display, the counter 182 intercepts the signal 180 and determines after a preset time interval to generate an increment signal 186. As illustrated in FIG. 6, channel 3 originally has 120 points and the comedy category has 72 points. In one embodiment if the increment is determined as a single point for a particular time interval and the time interval passes, channel 3 may then be incremented to 121 points and the comedy may be incremented to 73 points. In one embodiment the table of priority rules 184 may be continually monitored and updated to provide for a direct interactive feedback of user preferences.

In the embodiment of FIG. 5, a processor 198 is operative to receive viewing priority information 200, including the channel 190 points 194, genre 192 and genre points 196. In one embodiment the processor 198 may thereupon formulate the priority rules 114. In one embodiment, the priority rules 114 may be determined based on a simple calculation of channel points 194 plus genre points 196. Therefore, filter rule may include that any news event occurring on channel 2 may have a priority level of 110, the combination of 85 points 194 and 25 points 196. Comedy on channel 2 may have a point total of 157, drama on channel 2 having a total of 167 and so on. In this embodiment the viewing event indicators 112 may then be correlated with the priority rules 114 received from the processor 198 to generate the viewing events list 116 of the present invention.

FIG. 7 illustrates a flowchart of a method for the display of a viewing events list in accordance with one embodiment of the present invention. The method begins, step 210, by receiving a plurality of viewing event indicators which include a viewing event title, viewing event information and viewing event broadcast channel, step 212. As described above, the viewing event indicators 112 may be received from a program information database 102.

The next step, step 214, is receiving a plurality of priority rules from a priority module, wherein the priority rules include weighting factors associated with viewing categories, and in one embodiment the priority rules include point values associated with the viewing categories. As discussed above with regard to FIG. 6, points may be associated with a channel 190 and a genre 192 or any other suitable categorization, as recognized by one having ordinary skill in the art. The next step, step 216, is assigning each of the plurality of viewing events into one of the plurality of viewing categories. This step may be performed based on the information associated with the viewing event indicators or any other suitable application for mining this particular data.

Step 218 is prioritizing the viewing event indicators based on the category assignment for each of the plurality of viewing events and at least one priority rule. As discussed above, this may be performed by a processing device 104 of FIG. 1 such that step 220 is generating the viewing events list including the priority-based listing of the viewing event indicators. In one exemplary embodiment, FIG. 3 illustrates the viewing events list 116 including the viewing event indicators 160. Thereupon, one embodiment of the present invention is complete, step 222.

In another embodiment, the present invention may further provide for prioritizing the factors that generate the above-discussed priority list. For example, the genre of viewing events may be utilized to determine a viewing events list, wherein the types of genres may be re-adjusted. In one embodiment, a user may be provided with an interactive menu of the genre-types and the user could select an order of genre-types using an suitable approach, such as but not limited placing the genre-types in a priority list, assigning a priority level to each genre type, or any other suitable approach recognized by one having ordinary skill in the art.

Therefore, in this embodiment, even though the present invention generates an automatic viewing events list, this viewing events list may be adjusted based on user preferences or moods. For example, if a user typically watches sporting events and the present invention generates a viewing events list granting highest priority to sporting events, and the user wishes to focus on a different type of genre, such as comedy, the user may then override the existing priority system. Using any suitable technique, the user may select the comedy genre type such that the automatically generated viewing events list places comedy events at a highest priority level.

Therefore, the present invention provides for the display of a viewing events list wherein the viewing events list is a prioritized list for intelligent-based play list. As noted above, the play list may be generated based on both live and recorded viewing events. The prioritization of the viewing events may be done in any suitable manner, such as the point-based system monitoring not only viewing time of a particular genre plus viewing time of a particular broadcast station. As such, the present invention overcomes the previous information-overload of prior on-screen electronic program guide displays.

It should be understood that the implementation of other variations and modifications of the invention in its various aspects will be apparent to those of ordinary skill in the art, and that the invention is not limited by the specific embodiments described herein. For example, any other suitable criteria may be used in the point-based system, such as recording viewing of a particular viewing event, e.g., a sitcom, or viewing a category of broadcast channels such as a subscription-based movie channel broadcast that includes multiple movie channels such as HBO, Cinemax, Showtime or any other suitable movie channel. It is therefore contemplated to cover by the present invention, any and all modifications, variations, or equivalents that fall within the spirit and scope of the basic underlying principals disclosed and claimed herein.

1. A method for the display of a viewing events list, the method comprising:
receiving a plurality of viewing event indicators, wherein each of the plurality of viewing event indicators is associated with viewing event information;
prioritizing the viewing event indicators based on the viewing event information and at least one priority rule; and
generating the viewing events list including a priority-based listing of the viewing event indicators.

2. The method of claim 1 further comprising:
receiving the plurality of viewing event indicators from a viewing events database.

3. The method of claim 2 wherein the viewing events database includes viewing event indicators from an electronic program guide database and a digital recording device database.

4. The method of claim 1 further comprising:
retrieving the at least one priority rule from a priority module, wherein the at least one priority rule includes weighting factors.

5. The method of claim 4 wherein the weight factors are obtained using an interactive on-screen questionnaire.

6. The method of claim 4 wherein the weighting factors are obtained based on active monitoring of video output display.

7. The method of claim 4 wherein the weighting factors include a first point-based system for each of the plurality of broadcast channels and a second point-based system for each of the plurality of viewing event genres.

8. The method of claim 7 wherein the first point-based system includes incrementing points for a first time period of the display of a viewing event on each of the broadcast channels and the second point-based system further include incrementing points for a second time period of the of a viewing event consistent with each of the plurality of viewing event genres.

9. The method of claim 1 further comprising:
receiving an on-screen program display request; and
providing the viewing events list for display on a first screen portion of a display device.

10. A method for the display of a viewing events list, the method comprising:
receiving a plurality of viewing event indicators, wherein the viewing event indicators includes a viewing event title, viewing event information and viewing event broadcast channel;
receiving a plurality of priority rules wherein priority rules include point values associated with a plurality of viewing categories;
assigning each of the plurality of viewing events into one of the plurality of viewing categories;
prioritizing the viewing event indicators based on the category assignment for each of the plurality of viewing events and at least one priority rule; and
generating the viewing events list including a priority-based listing of the viewing event indicators.

11. The method of claim 10 wherein the plurality of priority rules are received from a priority module, wherein the at least one priority rule includes weighting factors associated with each of the plurality of viewing categories.

12. The method of claim 11 wherein the weight factors are obtained based on active monitoring of video output display.

13. The method of claim 12 wherein active monitoring of video output display includes incrementing one of a plurality of broadcast station counters and one of a plurality of genre counter for each time interval of active display of a corresponding genre display event on a corresponding broadcast station.

14. The method of claim 10 further comprising:
receiving an on-screen program display request; and
providing the viewing events list for display on a first screen portion of a display device.

15. An apparatus for the display of a viewing events list, the apparatus comprising:
a memory device operative to store a plurality of executable instructions; and
a processor operably coupled to the memory device and operative to receive the plurality of executable instructions such that the processor, in response to the executable instructions:
receives a plurality of viewing event indicators, wherein each of the plurality of viewing event indicators is associated with viewing event information;
prioritizes the viewing event indicators based on the viewing event information and at least one priority rule; and
generates the viewing events list including a priority-based listing of the viewing event indicators.

16. The apparatus of claim 15 further comprising:
a viewing events database; and
wherein the processing, in further response to the executable instructions:
receives the plurality of viewing event indicators from the viewing events database, wherein the viewing events database includes viewing event indicators from an electronic program guide database and a digital recording device database.

17. The apparatus of claim 16 wherein the processing, in further response to the executable instructions:
retrieves the at least one priority rule from a priority module, wherein the at least one priority rule includes weighting factors.

18. The apparatus of claim 17 wherein the weighting factors are obtained using at least one of: an interactive on-screen questionnaire and an active monitoring of video output display.

19. The apparatus of claim 17 wherein the weighting factors include a first point-based system for each of the plurality of broadcast channels and a second point-based system for each of the plurality of viewing event genres, the first point-based system includes incrementing points for a first time period of the display of a viewing event on each of the broadcast channels and the second point-based system further include incrementing points for a second time period of the of a viewing event consistent with each of the plurality of viewing event genres.

20. The apparatus of claim 16 wherein the processor further in response to executable instructions:
receives an on-screen program display request; and
provides the viewing events list for display on a first screen portion of a display device.
